(19) United States
(12) Patent Application Publication
(10) Pub. No.: US 2013/0218820 A1
(43) Pub. Date: Aug. 22, 2013

(54) Intelligent grouping system and method for mobile terminal contact directory

(71) Applicant: Beijing NetQin Technology Co., Ltd, (US)

(72) Inventors: Feng LI, Beijing (CN); Ping CHENG, Beijing (CN); Mei ZHU, Beijing (CN); Shihong ZOU, Beijing (CN); Yu LIN, Beijing (CN)

(73) Assignee: Beijing NetQin Technology Co., Ltd, Beijing (CN)

(21) Appl. No.: 13/854,090

(22) Filed: Mar. 30, 2013

(30) Foreign Application Priority Data
Sep. 30, 2010 (CN) 201010501259.6

(51) Int. Cl. G06N 5/02

(52) U.S. Cl. CPC G06N 5/02
USPC 706/20

(57) ABSTRACT

Disclosed is an intelligent grouping system and method thereof for a mobile terminal contact directory. The method may comprise connecting a client to a server in a wireless or wired manner to form an intelligent recognition system; synchronizing a contact directory of the client with the server; discovering, by the client, an event and extracting data information in the discovered event; analyzing, by the intelligent recognition system, the extracted data information, and automatically grouping the contact directory of the client according to the data information, the grouping information being synchronized between the client and the server through communication link; storing a contact directory grouping result in a database of the server; and displaying the grouping information on the client.

### CROSS REFERENCE TO RELATED APPLICATIONS

This application is a national stage entry of Patent Cooperation Treaty No. PCT/CN2011/079298 filed on Sep. 2, 2011 and claims priority to Chinese Application No. CN201010501259.6 filed Sep. 30, 2010, each of which are hereby incorporated by reference.

### FIELD OF THE DISCLOSURE

The present disclosure relates to mobile communication and information security. More particularly, the present disclosure relates to an intelligent grouping system and method for a mobile terminal contact directory.

### BACKGROUND

In order to group entries in a mobile terminal contact directory, a user manually selects and arranges the entries one-by-one. Accordingly, the operations are complex and the operability is poor.

With the development of the mobile communication technology, mobile phones have become one of the most popular communication tools for people. Most mobile phones provide functions for storing and managing contact directories. Accordingly, mobile phone users may record the names, phone numbers, and company names of their contacts as cards. Further, a contact may be searched based on his/her names or phone numbers.

The combination of the contact directory and the communication tool provides great convenience for users. Users may become increasingly accustomed to storing phone numbers on their mobile phones. Further, with the development of the Internet, e-mails, and Instant Messengers, the communication and forming of connections between people are becoming increasingly convenient. Indeed, social circles are becoming wider than before. As a result, a mobile phone user's contact directory may grow very rapidly. For some business professionals, the contacts in the contact directory on their mobile phones may number in the hundreds or even thousands.

Contacts in a user's contact directory may belong to different social circles. As a result, there may be great inconvenience in the management of contacts from different social circles in the same the contact directory. Most management software for mobile phone contact directories allow users to store many attributes of contacts, such as company name, email, or address, and the like. The management software may also allow a user to classify the contacts based on which social circle the contact belongs to. However, the classes are input manually by the user. As a result, the work required is high and the efficiency is low.

The disclosure of any information in the Background section of the present disclosure intends to improve the readers' comprehension of the overall background of the present disclosure only, and should not be regarded as admission or implication that such information constitutes the prior art which is well-known to one ordinarily skilled in the art.

### SUMMARY

The present disclosure relates to an intelligent grouping system and method for a mobile terminal contact directory. In some embodiments, the present disclosure provides for systems and methods of recognizing and categorizing personal social circles more conveniently and more accurately. In some embodiments, connections among contacts may be adjusted intelligently, i.e. a contact directory stored in a mobile terminal may be grouped based on a plurality of types of information.

Traditional management software for mobile phones employ rudimentary and manual methods of editing contact directories. Thus, a user's desire to operate such a method may be weak. Accordingly, the method does not facilitate the management of the social circles within the contract directory.

According to one aspect of the present disclosure, a method of grouping contacts in a mobile terminal contact directory intelligently is provided. The method may comprise connecting a client to a server in a wireless or wired manner to form an intelligent recognition system; synchronizing a contact directory of the client with the server; the client discovering an event and extracting data information from the discovered event; the intelligent recognition system analyzing the extracted data information, and automatically grouping the contact directory of the client according to the data information, the grouping information being synchronized between the client and the server; storing a contact directory grouping result in a database of the server; and displaying the grouping information on the client.

According to another aspect of the present disclosure, an intelligent grouping system for grouping contacts in a mobile terminal contact directory is provided. The system may comprise a client and a server. The client may be connected to the server in a wireless or wired manner to form an intelligent recognition system. The client may be configured for discovering an event and displaying grouping information. The server may be configured for making a series of logical decisions on data information in a contact directory and the location information to filter out groups that meet requirements, store the groups, and then synchronize the grouping information with the client.

According to another aspect of the present disclosure, an intelligent grouping system for grouping contacts in a mobile terminal contact directory is provided, wherein the client may further comprise: an SMS (short message service) message monitoring unit that may be configured for discovering an SMS message group sending event, automatically generating groups, notifying a data management unit of the groups, and storing the same; a location information management unit that may be configured for reading location information of the mobile terminal and notifying the data management unit of the same; the data management unit may be configured for storing grouping information, and meanwhile, sending the contact directory and the location information to a communication unit; and the communication unit may be configured for synchronizing the grouping information, the contact directory, and the location information to the server.

According to another aspect of the present disclosure, an intelligent grouping system for grouping contacts in a mobile terminal contact directory is provided, wherein the server may further comprise: a communication unit that may be configured for receiving data from the client and passing the data to a statistic and calculation unit for background data analysis, wherein the communication unit may also synchronize the analysis result with the client; and a statistic and calculation unit that may be configured for calculating the analysis result and storing the same into a database.

The intelligent grouping system and method thereof according to the present disclosure may advantageously identify and arrange the habits and customs of a user so as to automatically generate grouping information. Advantageously, the present disclosure is more appropriate for real situations, provides greater operability of such a system or method, and provides greater value and utility of the groups thus classified.

### BRIEF DESCRIPTION OF THE DRAWINGS

The features and advantages of the present disclosure will be clearer when the description of the attached drawings and the detailed description of the present disclosure below are referenced.

FIG. 1 is a flow chart depicting an event-triggered intelligent grouping;

FIG. 2 is a flow chart depicting an intelligent grouping based on contact directories, locations, and aggregation frequencies;

FIG. 3 is a flow chart depicting the intelligent grouping of groups of interests based on contact directories, locations, and frequencies of arriving at locations; and

FIG. 4 is a schematic block diagram of a configuration of a system.

### DETAILED DESCRIPTION

Various embodiments of the present disclosure will be referenced specifically, and instances of these embodiments are shown in the attached drawings and description hereinafter. Although the present disclosure is described in conjunction with the exemplary embodiments, one skilled in the art should appreciate that the present specification does not intend to limit the present disclosure into those exemplary embodiments. On the contrary, the present disclosure intends to not only cover all those exemplary embodiments, but also all substitutions, modifications, equivalents, and other embodiments that fall within the spirit and scope of the present disclosure which is defined by the attached claims.

According to an embodiment of the present disclosure, a method of grouping contacts in a mobile terminal contact directory intelligently is provided. The method may comprise connecting a client to a server in a wireless or wired manner to form an intelligent recognition system; and the client may synchronize data information with the server. Preferably, the client may synchronize data such as the contact directory and location information with the server periodically. The server may receive the data from the client, perform a background data analysis, and synchronize the analysis result with the client; and store the results in a database. The grouping information may be synchronized with the client through the communication link between the server and the client. The grouping information may be displayed.

In the method of grouping contacts in a mobile terminal contact directory intelligently according to the present disclosure, a name of a client, whose information is not stored in a contact directory of another client, may be automatically added to the contact directory of the another client or may be automatically set to be invisible to the another client.

The present disclosure provides a method of grouping contacts in a mobile terminal contact directory intelligently. The method may comprise receiving a group-sent SMS message by a receiving unit. Recipients of the group-sent SMS message may be grouped by a grouping unit based on the SMS message received by the receiving unit, and all recipients of the group-sent SMS message may be added to the group as the contents of the group. Preferably, the recipients to be grouped may be classified as either recipients who have already existed in the client or recipients who have not existed in the client. The contents of the group-sent SMS message may be extracted by a content extracting unit, and the group may be named after the contents of the SMS message. The contents of the group and the name of the group may be stored in a storage unit. The contents of the group and the name of the group may be displayed by a display unit.

A user of the client may edit the name of the group by using or operating an editing unit. In the above groups of the client, the client may only display the recipients who have already existed in the client.

Subsequently, this grouping information may be preferably synchronized with the server by the client and stored into a database.

In the method of grouping contacts in a mobile terminal contact directory intelligently according to the present disclosure, discovering an event may comprise discovering the location information of the mobile terminal, and grouping the client intelligently based on the location information and aggregation frequency.

In the method of grouping contacts in a mobile terminal contact directory intelligently according to the present disclosure, the method may further comprise the client synchronizing the contact directory with the server in advance, and the client binding with an account, and associates with a phone number; the server generating a knowledge connection with respect to one another based on contents of contact directories of various clients. The client may record its own location information by a predetermined time interval and synchronize the same with the server. The server may arrange and analyze the location information and several clients that may have knowledge connections with respect to one another will be designated as one group automatically once it is found that they aggregate together over a predetermined number of times; the server may designate clients as one group based on the time and space connections of the clients; and the server may synchronize the grouping information, which is generated intelligently, to the client periodically.

In the method of grouping contacts in a mobile terminal contact directory intelligently according to the present disclosure, discovering an event may comprise discovering a location of the mobile terminal, a frequency of aggregating or arriving at the location, and details of the location information; identifying the preference of each person and then grouping the client intelligently based on the contact directory, the location, the frequency of arriving at the location, and the details of the location information.

In the method of grouping contacts in a mobile terminal contact directory intelligently according to the present disclosure, the method may further comprise the client binding with an account, and associates with a telephone number; the client synchronizing the contact directory of the mobile terminal with the server; the server analyzing and generating connections with respect to one another based on contents of contact directories of various clients; the client recording its own location information by a predetermined time interval, and synchronizing the same with the server or recording the location information manually by the user; the server recognizing the class of each marked location; the server determining preferences; the server identifying users who know each other and have the same preferences based on the connections of accounts or telephone numbers of each client, and generating one group of interest automatically; and the server synchronizing the generated group of interest with the client periodically.

According to an embodiment of the present disclosure, a system for grouping contacts in a mobile terminal contact directory intelligently is provided. The system may comprise a client and a server. The client may connect to the server in a wireless or wired manner to form an intelligent recognition system.

The client may discover an event and display grouping information. The server may make a series of logical decisions on the contact directory and location information to filter out groups that meet requirements, store the groups, and then synchronize the grouping information with the client through the communication link.

In an intelligent grouping system for grouping contacts in a mobile terminal contact directory according to the present disclosure, the client may further comprise the following units. An SMS message monitoring unit may discover an SMS message group sending event, automatically generate a group of the sent event, and notify the data management unit of the group of the sent event and store the same. A location information management unit may read the location information of the mobile terminal and notify the data management unit of the same. The data management unit may store the grouping information and may send the contact directory and the location information to a communication unit. The communication unit may synchronize the grouping information, the contact directory, and the location information with the server.

In an intelligent grouping system for grouping contacts in a mobile terminal contact directory according to the present disclosure, the server may comprise a communication unit and a statistic and calculation unit. The communication unit may receive data from the client and pass the data to the statistic and calculation unit for background data analysis. The communication unit may also synchronize the analysis result with the client. The statistic and calculation unit may calculate the result of the background data analysis and store the same into a database.

The intelligent grouping system for grouping contacts in a mobile terminal contact directory intelligently as provided by the present disclosure may require two major components, i.e., the client and the server. The functions of the client may be achieved by, but are not limited to, software installed in the client to make decisions on events and group the contact directory intelligently. One of ordinary skill in the art would appreciate that the functions of the client may be achieved by hardware or firmware. The client may be a mobile terminal, a personal computer, a cell phone, a UE, or other mobile communication devices, but is not limit to those embodiments.

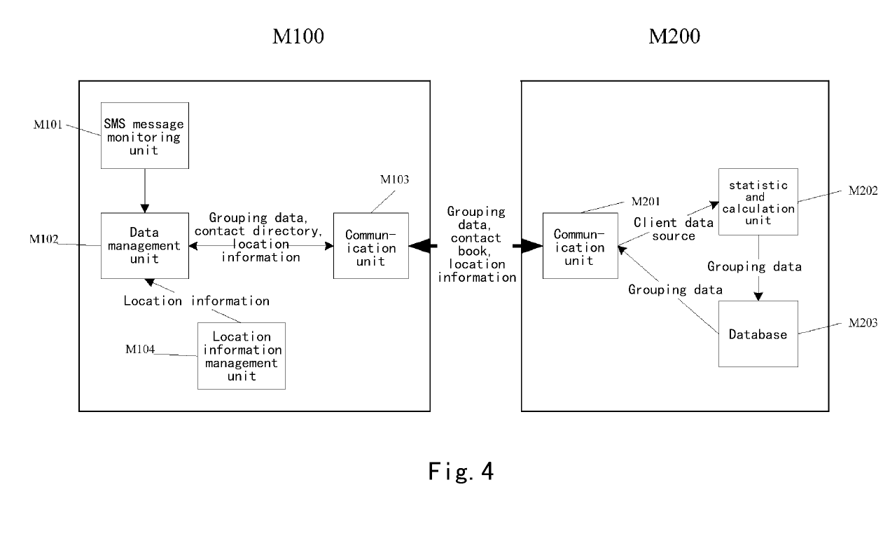

FIG. 4 is a schematic block diagram depicting the configuration of an intelligent grouping system according to the present disclosure.

An intelligent grouping system provided by the present disclosure may comprise a client and a server. The client may be connected to the server in a wireless or wired manner to form an intelligent recognition system. In FIG. 4, M100 denotes the client and M200 denotes the server.

The client may be mainly used for discovering an event such as an SMS message group-sending event and displaying grouping information. M101 may be an SMS message monitoring unit for discovering an SMS message group-sending event, automatically generating groups, and notifying a data management unit M102 of the groups. M104 may be a location information management unit for reading the location information of the mobile terminal and notifying the data management unit M102 of the same. The data management unit M102 may store the grouping information, and may send the contact directory and location information to the communication unit M103. The communication unit M103 may synchronize the grouping information, the contact directory, and the location information with the server.

The server may make a series of logical decisions on the contact directory and the location information to filter out groups that meet certain requirements and then store the groups. The server may synchronize the grouping information with the client through the communication link. A communication unit M201 may receive data from the client, and forward the data to a statistic and calculation unit M202 to perform background data analysis. M201 may also synchronize the analysis result with the client. The statistic and calculation unit M202 may calculate the results of the background data analysis and store the same into a database M203.

According to an embodiment of the present disclosure, the intelligent grouping system may comprise an intelligent grouping system based on an event trigger, and another intelligent grouping system based on contact directories, location, and aggregation frequency, etc.

According to an embodiment of the present disclosure, in the event-triggered intelligent grouping system, when an SMS message is group-sent, the client may recognize such an event and classify the recipients into a same group automatically. Meanwhile, an abstract may be extracted from the contents of the SMS message as the name of the group. The user of the client may edit the name.

According to an embodiment of the present disclosure, the intelligent grouping system based on contact directories, location, and aggregation frequency may perform the following operations:

a. The client may synchronize the contact directory of the mobile terminal with the server in advance, and bind with an account, and associate with a phone number.
b. The server may establish a connection for each of the clients, i.e. allow clients to recognize each other based on the contents of the contact directories of various clients (accounts).
c. The client may record its own location information by a predetermined time interval, and synchronize the location information with the server.
d. The server may arrange and analyze the location information, and several mobile terminals (people) that know each other will be designated as one group automatically once it is found that they aggregate together over a predetermined number of times.
e. In the operation of (d), the conditions that may be used to designate a group may be one of, for example, (1) during a same time period, for example, a 10 minute interval from Aug. 4, 2010, 9:10 to 9:20; (2) a certain number of people, for example, six people, A, B, C, D, E, and F, aggregate in close vicinity to the same coffee bar, the distance therebetween is less than 200 meters, and this distance may be adjusted based on the real circumstances of the location; (3) the six people, A, B, C, D, E, and F, have aggregated in the same coffee bar or other location before; (4) the six people, A, B, C, D, E, and F, have aggregated together, for example, at least 3 times, wherein the threshold of the aggregation may be adjusted based on predetermined situations; and (5) for any two of the six people, A, B, C, D, E, and F, there is a path, which is composed of the connections in the contact directories, that links these two people together. In other words, the six people, A, B, C, D, E, and F, may be connected in series.
f. In the case where (d) and (e) are satisfied, the server may designate the six people, A, B, C, D, E, and F, as one group.
g. The server may synchronize the grouping information, which is generated intelligently, with the client periodically.
h. When only B, C, and D are in the contact directory of A, the client of A may show only B, C, and D within the same one group, and E and F may not be shown.

According to another embodiment of the present disclosure, the intelligent grouping system may recognize the preferences of each person based on the contact directory, the location, the frequency of aggregating or arriving at a certain location, and the details of the location. The information may include the name of the location, the type of the location, etc., and is divided into the groups based on interests. The intelligent grouping system may perform following operations:

a. The client may record its own location information based on a predetermined time interval and synchronize the location information with the server. The location information may also be recorded manually by the user, for example, by marking.
b. The server may recognize the class of a location, for example, a badminton stadium, a restaurant such as Sichuan cuisine, Hunan cuisine, or Cantonese cuisine, a view spot such as a mountain, a culture landscape, or a historical site, a cinema, a bar, a KTV, or a chess-and-card room, etc.
c. When a person visits a certain type of locations for several times, for example, 10 times (the number of times may be adjusted as required), the server may determine the preferences of this person as this type, for example, preferring a restaurant such as Sichuan cuisine.
d. The server may identify people who know each other based on the connections between the accounts or phone numbers of each client. The server may identify the people who know each other and have the same preferences based on the preference determination results of (c). For example, all the six people, A, B, C, D, E, and F, may have a cuisine preference such as Sichuan cuisine.
e. The server may synchronize the intelligently generated group of interests or preferences with the client periodically.
f. When only B, C, and D are in the contact directory of A, the client of A may only show B, C, and D within the same group, and E and F may not be shown.

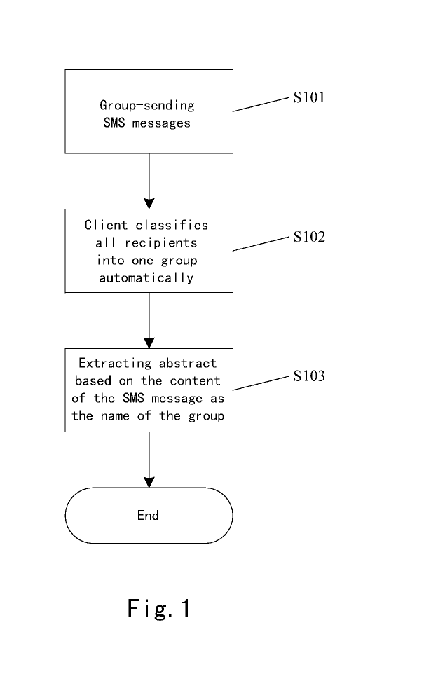

FIG. 1 depicts a flow chart of event-triggered intelligent grouping. At step S101, an SMS message may be group-sent. At step S102, the client may recognize an event of group sending an SMS message and classify the recipients into the same group automatically. At step S103, an abstract may be extracted based on the contents of the SMS message as the name of the group. The user may also edit the name.

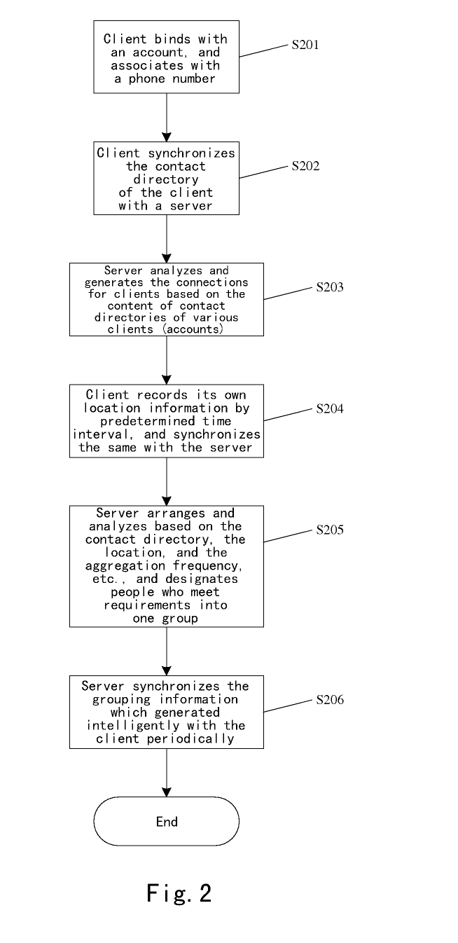

FIG. 2 depicts the intelligent grouping based on the contact directory, the location, and the aggregation frequency. At step S201, the client may bind with an account and associate with a phone number. At step S202, the client may synchronize the contact directory of the mobile terminal with the server. At step S203, the server may establish a connection for each other, i.e. the clients may recognize each other based on the contents of the contact directories of various clients (accounts). At step S204, the client may record its own location information by a predetermined time interval, and synchronize the location information with the server. At step S205, the server may arrange and analyze the location information, and several mobile terminals (users) that know each other will be designated as one group automatically once it is found that they aggregate together over a predetermined number of times. At step S206, the server may synchronize the grouping information, which may be generated intelligently periodically with the client. When only B, C, and D are in the contact directory of A, the client of A may only show B, C, and D within the same one group, and E and F may not be shown.

In particular, the conditions that may be used to designate one group may comprise: during a same time period, for example, a 10 minute interval from Aug. 4, 2010 9:10 to 9:20; and for example, six people, A, B, C, D, E, and F, aggregate close to the same coffee bar, the distance therebetween is less than 200 meters, and this distance may be adjusted based on predetermined situations of the location. For example, the six people, A, B, C, D, E, and F, aggregated in this coffee bar or any other place before. In an example, the six people, A, B, C, D, E, and F, have aggregated together for at least 3 times, and the threshold of aggregation may be adjusted based on the predetermined situations. In another example, for any two people in the six people, A, B, C, D, E, and F, there is a path, which is composed of the connections in the contact directory, that links these two people together. In other words, the six people, A, B, C, D, E, and F, may be connected in series.

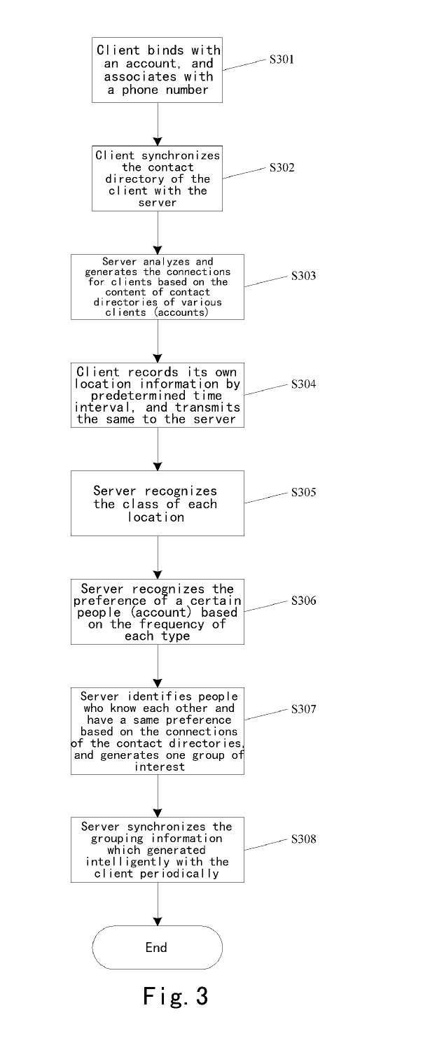

FIG. 3 depicts a flow chart of the intelligent grouping system recognizing the preferences of a person based on the contact directory, the location, the frequency of aggregating or arriving at a location, and the details of the location. The location information may include the name of the location, types, etc., and divides the group of interest intelligently. At step S301, the client may bind with an account, and associate with a telephone number. At step S302, the client may synchronize the contact directory of the mobile terminal with the server. At step S303, the server may analyze and establish the connections for each of clients based on the contents of the contact directories of various clients (accounts). At step S304, the client may record its own location information based on a predetermined time interval and synchronize the location information with the server.

The user may also record the location information manually, for example, by marking. At step S305, the server may recognize the class of each marked location, for example, a badminton stadium, a restaurant such as Sichuan cuisine, Hunan cuisine, or Cantonese cuisine, a view spot such as a mountain, a culture landscape, or a historical site, a cinema, a bar, a KTV, or a chess-and-card room, etc. At step S306, when a person visits a certain type of locations several times, for example, 10 times (the number of times may be adjusted as desired), the server may make determinations on the preferences of the person. For example, the server may determine that the person has restaurant preference, such as Sichuan cuisine restaurants. At step S307, the server may identify people who know each other based on connections between the accounts or phone numbers of each client and pick those people who know each other. The server may then identify the people who know each other and have the same preferences based on the preference determination results. For example, all six people, A, B, C, D, E, and F, may prefer cuisines such as Sichuan cuisine. Accordingly, a group of interest may generated automatically. At step S308, the server may periodically synchronize the intelligently generated group of interests with the client. When only B, C, and D are in the contact directory of A, the client of A may only show B, C, and D within the same one group, and E and F may not be shown.

The foregoing description of specific exemplary implementations of the present disclosure is for the purpose of illustration and exemplification. This description does not intend to exhausts the present disclosure, or to limit the present disclosure to the disclosed specific forms, and it is obvious to make many modifications and alterations according to the teachings above. For example, optionally, the above one or more steps can be performed automatically, or cannot be performed without the confirmation from the client. The purpose of selecting and describing the exemplary embodiments is to explain the specific principles of the present disclosure and their real applications, such that one skilled in the art can achieve and employ the different various exemplary implementations of the present disclosure and their different various selections and modifications. The scope of the present disclosure intends to be limited by the attached claims and their equivalents.

What is claimed is:

1. A method of grouping contacts in a client contact directory intelligently, comprising:
connecting a client to a server in a wireless or wired manner to form an intelligent recognition system;
synchronizing a contact directory of the client with the server;
discovering, by the client, an event and extracting data information in the discovered event;
analyzing, by the intelligent recognition system, the extracted data information, and automatically grouping the contact directory of the client according to the data information, the grouping information being synchronized between the client and the server through communication link;
storing a contact directory grouping result in a database of the server; and
displaying the grouping information on the client.

2. The method according to claim 1, further comprising a name of a client, whose information is not stored in a contact directory of another client, in a group is automatically added to the contact directory of another client or is automatically set to be invisible.

3. The method according to claim 1 or 2, wherein discovering an event comprises discovering an SMS message group-sending event, the contact directory is grouped intelligently by the client of the intelligent recognition system based on the SMS message group-sending event.

4. The method according to claim 3, wherein when the SMS message group-sending event occurs, the client recognizes the type of SMS message group-sending events, classifies the recipients of the SMS message into a same group, and extracts an abstract from the contents of the SMS message as the name of the group, or the user edits the name.

5. The method according to claim 1 or 2, wherein discovering an event comprises discovering the location information of the client, and grouping the contact directory by the server of the intelligent recognition system based on the location information and aggregation frequency.

6. The method according to claim 5, further comprising:
synchronizing, by the client, the contact directory of the client with the server, binding the client with an account, and associates the client with a phone number;
generating, by the server, a recognition connection for each of the clients based on the contents of the contact directories of various clients;
recording, by the client, its own location information by predetermined time interval, and synchronizing the location information with the server;
arranging and analyzing, by the server, the location information, and the clients which have known with each other being designated as one group automatically once it is found that they aggregate together over a predetermined number of times;
designating, by the server, clients as one group based on the time and space connections of the clients; and
synchronizing, by the server, the grouping information, which is generated intelligently, with the client periodically.

7. The method according to claim 1 or 2, wherein discovering an event comprises: discovering the location of the client, the frequency of aggregating or arriving at the location, and the details of the location information, preference of each user is identified based on the contact directory, the location information, the frequency of aggregating or arriving at the location, and the details of the location information, and the client is grouped intelligently by the server of the intelligent recognition system.

8. The method according to claim 7, further comprising:
binding the client with an account, and associates the client with a telephone number;
synchronizing, by the client, the contact directory of the client with the server;
analyzing and generating, by the server, the connections for each of the clients based on the contents of the contact directories of various clients;
recording, by the client, its own location information by a predetermined time interval, and synchronizing with the location information with the server, or recording the location information manually by the user;
recognizing, by the server, the class of each marked location;
determining, by the server, the preference of the users of the clients;
identifying, by the server, users who know each other and have a same preference based on the connections of accounts or telephone numbers of each client, and generating one group of interest automatically; and
synchronizing, by the server, the generated group of interest with the client periodically.

9. A intelligent grouping system comprising a client and a server for grouping contacts in a client contact directory, wherein
the client is connected to the server in a wireless or wired manner to form an intelligent recognition system,
the client is configured for discovering an event and displaying grouping information;
the server is configured for making a series of logical decisions on a contact directory and location information to filter out groups that meet requirements, and storing the groups; and
the server is configured to synchronize the grouping information with the client through a communication link.

10. The intelligent grouping system according to claim 9, wherein the client further comprises:
an SMS message monitoring unit configured for discovering an SMS message group sending event, automatically generating groups, and notifying a data management unit of the groups and storing the same;
a location information management unit configured for reading the location information of the mobile terminal and notify the data management unit of the same;
the data management unit configured for storing the grouping information, and sending the contact directory and location information to the communication unit; and
the communication unit configured for synchronizing the grouping information, the contact directory, and the location information with the server.

11. The intelligent grouping system according to claim 9 or 10, wherein the server further comprises:
a communication unit configured for receiving data from the client, and passing the data to a statistic and calculation unit for background data analysis, synchronizes the analysis result with the client; and
the statistic and calculation unit configured for calculating the result of the background data analysis and storing the same into a database.

12. An intelligent grouping system for grouping contacts in a client contact directory, wherein the system performs the method according to any of claims 1-9 to divides the group of interest intelligently on the client.
